(19) United States
(12) Patent Application Publication
(10) Pub. No.: US 2016/0057311 A1
(43) Pub. Date: Feb. 25, 2016

(54) Method of Providing Digital Directory Information for a Printed Document

(71) Applicant: Siter, LLC, Sao Paulo - CEP (BR)

(72) Inventor: Athos Comolatti, Sao Paulo - CEP (BR)

(21) Appl. No.: 14/468,085

(22) Filed: Aug. 25, 2014

(51) Int. Cl. H04N 1/32; G06F 17/30

(52) U.S. Cl. CPC H04N 1/32144; G06F 17/30958; H04N 2201/3269

(57) ABSTRACT

Embodiments of the invention described in this patent provide a process that improves the manner in which the readers of a printed journal can access contact information of a company listed in this index of advertised companies and/or advertisers. The reader may query, for example, company main phone number and address, company branches' addresses, company department phone numbers, phone numbers and addresses of retail stores, phone numbers and addresses of technical support places, business times and other important information for communication between the magazine reader and the company advertised on the magazine index. This process, therefore, facilitates the contact and access of readers of printed media to the advertised companies on index pages of printed magazines.

### BACKGROUND

Despite the advent of online media (media that are accessed through the Internet) over the last two decades, offline media (accessed outside the Internet) are still active and functional, since each type of media offers a unique experience to its target audience. Printed media, for instance, creates a strong connection among its readers and advertisers through newspapers, weekly magazines, monthly magazines and print newsletters, and offer credibility to conveyed concepts and ideas.

On the other hand, over recent decades, publication of the domain's name on printed advertisements has become increasingly common, since websites became the focal point of communication between the advertiser and its customer market. It is uncommon to find printed advertisements in which the advertiser's website name is not present.

In order to facilitate contact between the readers and the advertised companies/advertisers, some print magazines have index pages on which these companies are listed. Sometimes the company list includes company domain names and optionally other additional information, such as main phone number and address, becoming a useful and unified source of information of the listed companies to the readers.

### SUMMARY

When a printed magazine creates a page in which it lists the advertised companies and/or advertisers of an edition, it intends to help establish contact between these companies and the readers (example FIG. 1). However, most of the advertised companies have multiple contact numbers, offices and places of sale. It is impossible to provide all contact information of the company to the reader through the printed media, since some of these companies have hundreds or even thousands of contact numbers and addresses in the form of offices, departments, and points of sale or technical support networks, which can be contacted or visited.

The most common alternative employed by the printed periodic publishers to solve this issue is to list the domain name of the listed company (example FIG. 1-10), followed or not by some complementary information, such as: the main telephone number or main company address.

On the index page query method and system of advertised companies and/or advertisers of printed journals described in this patent, the magazine publishes in this index page a smartphone or tablet application (example FIG. 1-20), which contains all contact information, phone numbers and addresses of stores, all mailing addresses, all contact numbers and other relevant information, of all companies listed in that edition.

This application may be property of the magazine itself or third parties, and allows access to contact information of the companies listed on the index page through the brands or domain names of each listed company.

This application may as well feature the complete list of companies of a certain edition of a printed magazine located by keywords, for example: “Magazine 88” (Magazine edition number 88), or through bar code scanning (or QR Code, in case the magazine does not already own a bar code) or the magazine itself (example FIG. 1-30).

The application may use the same bar code (or QR Code) used in retail for identification of the magazine which is found on the magazine cover (ISSN and similar) or create its own number to identify that specific edition.

In case of bar code scanning (or QR code) of the magazine through the smartphone or tablet application (example FIG. 2-30), the user shall receive a complete list of the advertised companies and/or advertisers of that particular edition (example FIG. 2-40). This list may come in alphabetical order of brands, domain names or distance (shortest distance closer) between the mobile/tablet user and the places of sale of the companies listed on the index.

The main advantage of this index page query method and system of advertised companies and/or advertisers of printed journals is that magazines shall provide an improved service for its readers, in which a single smartphone/tablet application shall enable queries for all phone numbers and addresses of the companies listed in this index in a fast and integrated manner and with geolocalisation.

The magazines may also have clearer index pages of listed companies and/or advertisers, with less information, once all-important information shall be queried through a smartphone/tablet application.

### DESCRIPTION OF THE DRAWINGS

FIG. 1—Example of an index page of advertised companies and/or advertisers of a printed magazine. On this page, multiple companies are listed in alphabetical order, by domain name, category or region. The magazine lists the brand and its respective domain name, or may include few complementary information, such as main phone number or main address.

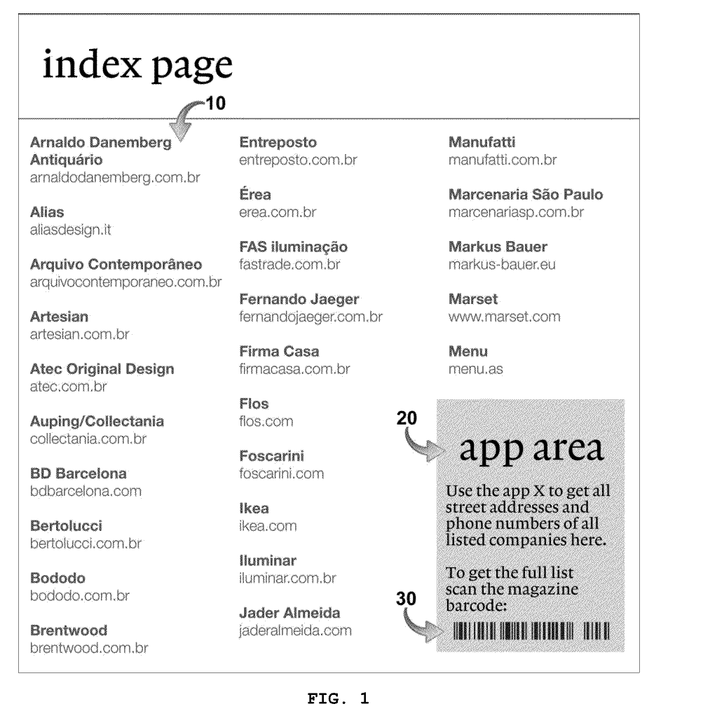

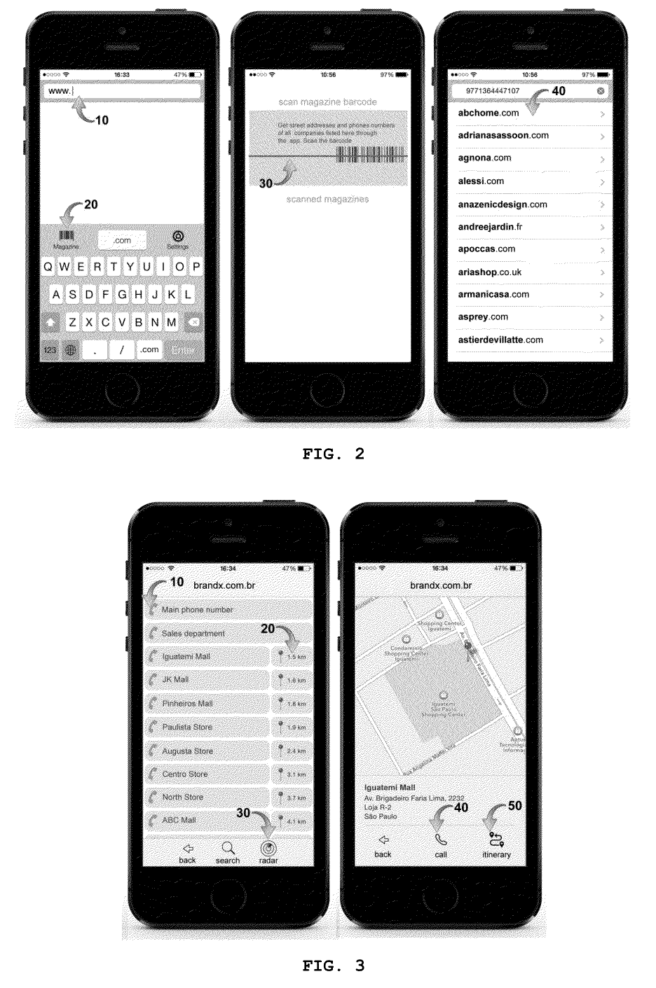

In this specific example, only the brand and its respective domain name are shown (FIG. 1-10).

On this same page, according to the index page query method and system of advertised companies and/or advertisers for printed journals described in this patent, the magazine shall advertise a smartphone/tablet application in which all relevant contact information of the listed companies is presented to the reader. Some of them may be: Company department phone numbers, company branches' numbers, phone numbers and addresses of places of sale, phone numbers and addresses of company technical support places, closest phone numbers and addresses to the location of the query (geolocalisation), business times, etc.

The user of the application described above may also scan, through this same application, the magazine's bar code (or QR code) in order to receive the full list of advertised companies and/or advertisers of that specific edition (example FIG. 1-30). The bar code (or QR code) may be the same code used on the magazine cover (ISSN and similar) or may be created specifically for this task.

In case of bar code scanning, the application user shall receive the full list of advertised companies, according to FIG. 2-40.

FIG. 2—Example of application interface for smartphones and/or tablets which lists contact information or a certain company through its domain name (FIG. 2-10) or which allows for bar code scanning (or QR code) of a magazine in order to receive the full list of advertised companies and/or advertisers of that edition (FIG. 2-20 and FIG. 2-30). This company list (FIG. 2-40) may be in alphabetical order, by domain name or by order of closest addresses to the actual address (geolocalisation). The application user, after receiving the full list of advertised companies, may choose to receive additional information regarding a specific company, as shown in FIG. 3.

FIG. 3—Example of smartphone/tablet application interface that, once a company is chosen through its domain name, according to FIG. 2-10, or chosen through a list, according to FIG. 2-40, the application lists (FIG. 3-10): company department phone numbers, company branches' numbers, phone numbers and addresses of places of sale, phone numbers and addresses of company technical support locations (FIG. 3-20), closest phone numbers and addresses to the location of the query (geolocalisation) FIG. 3-20, business times and any other relevant information for the application user to contact or visit the company.

### DETAILED DESCRIPTION OF EXEMPLARY EMBODIMENTS

Magazine, newspapers and other printed publication readers may, through this index page query method and system of advertised and/or advertiser companies described in this patent, thoroughly and easily contact the listed companies. This method and system is described in a detailed manner, as follows:

1) Magazines, newspapers or other periodic publications shall contain a page, which lists all advertised/advertiser companies in that edition (FIG. 1). The index page of advertised companies and/or advertisers shall include the company list (FIG. 1-10) in alphabetical order by brand or domain name, integrated or not by region or category. This page may also include information to the readers about a smartphone/tablet application (FIG. 1-20) in which all contact information of the listed companies may be queried. It may also include a bar code (or QR code) FIG. 1-30 which may be used by the application in order to properly identify the edition. This bar code (or QR code) may be the same one used by the retail for identification of the publication, which is normally found on the printed cover of the publication (ISSN and similar), or another code, numerical or alphanumerical, previously agreed between the Publisher of the periodic publication and the application Publisher.

2) A smartphone/tablet application (example FIG. 2) which scans the bar code (or QR code) published on the index page FIG. 1-30 of advertised companies and/or advertisers of a magazine, newspaper of another printed journal. Otherwise, a keyword may be created by the application Publisher and the printed periodic Publisher, in a way that properly identifies the publication and replaces the bar code (or QR code) scan process. For example, Keyword: “Magazine 99”. Where 99 would be the edition number of the printed journal. Once the bar code is scanned (or QR code, or keyword) FIG. 2-30, the application shall reproduce the printed company list (FIG. 2-40). This reproduction may be in alphabetical order by brand name, domain names or physical proximity (geolocalisation). As soon as the list of advertised companies and/or advertisers is shown, the application allows the smartphone/tablet user to query specific contact information of a certain company from the list (example FIG. 3), for example: company department phone numbers, company branches' numbers, phone numbers and addresses of places of sale, phone numbers and addresses of company technical support places, closest phone numbers and addresses to the location of the query (geolocalisation) FIG. 3-20, business times, etc.

3) The application shall also allow direct access to this company information in case the tablet/smartphone user provides the brand name or domain name (example FIG. 2-10) of the advertised company and/or advertiser.

1. A method of providing digital directory information for a printed document, for access to contact information of companies, by a mobile computing device, the method comprising:
compiling a digital directory for entities identified in the printed document, the directory comprising a set of contact information items for each entity;
printing a directory key in the printed document linking the printed document and the digital directory; and
on entry of the directory key into the mobile device, providing the digital directory for display on the mobile device.

2. The method of claim 1, wherein the directory key linking the printed document and the digital directory shall be properly identified by a keyword agreed between the publisher of the digital directory and the publisher of the printed document.

3. The method of claim 1, wherein the directory key linking the printed document and the digital directory shall be properly identified by its own bar code (or QR code) used by the retail for identification of the particular edition of the printed document (ISSN and similar).

4. The method of claim 1, wherein the directory key linking the printed document and the digital directory shall be properly identified by a bar code (or QR code) previously agreed between the publisher of the digital directory and the publisher of the printed document.

5. The method of claim 2, wherein the set of contact information items for each entity provided in the digital directory includes (but is not limited to): the complete list of office phone numbers and addresses, complete list of retail store phone numbers and addresses, company branches' business times, complete list of phone numbers and addresses of company technical support places.

6. The method of claim 3, wherein the entry of the directory key is carried out by scanning the bar code established on claim 3, and wherein the set of contact information items for each entity provided in the digital directory includes (but is not limited to): the complete list of office phone numbers and addresses, complete list of retail store phone numbers and addresses, company branches' business times, complete list of phone numbers and addresses of company technical support places.

7. The method of claim 4, wherein the entry of the directory key is carried out by scanning the bar code established on claim 4, and wherein the set of contact information items for each entity provided by the digital directory includes (but is not limited to): the complete list of office phone numbers and addresses, complete list of retail store phone numbers and addresses, company branches' business times, complete list of phone numbers and addresses of company technical support places.
